(19) United States
(12) Patent Application Publication
(10) Pub. No.: US 2010/0161979 A1
(43) Pub. Date: Jun. 24, 2010

(54) PORTABLE ELECTRONIC ENTITY FOR SETTING UP SECURED VOICE OVER IP COMMUNICATION

(75) Inventors: Marc Bertin, La Celle Les Bordes (FR); Eric Alzai, Trets (FR)

Correspondence Address: YOUNG & THOMPSON, 209 Madison Street, Suite 500, Alexandria, VA, 22314, US

(73) Assignee: OBERTHUR CARD SYSTEMS SA, Paris (FR)

(21) Appl. No.: 12/063,149

(22) PCT Filed: Nov. 24, 2006
(86) PCT No.: PCT/FR06/02585

§ 371 Date: Feb. 7, 2008

(30) Foreign Application Priority Data
Nov. 25, 2005 (FR) 0511983

(51) Int. Cl. H04L 12/66; H04L 9/32

(52) U.S. Cl. 713/168; 370/352; 713/150

(57) ABSTRACT

A portable electronic entity includes an interface (11) to a host station and communication elements for executing a VoIP communication application between the portable electronic entity (100) thus connected to the host station (SH) and a communication server (SER) connected to the host station (SH) via a communication network (NET). The entity (100) further includes elements for securing the VoIP application for making secure the execution of the VoIP application between the portable cryptographic entity (100) and the communication server (SER), in accordance with a selected cryptographic mode.

The present invention relates to making secure a call set up between a portable electronic entity and a communication server via a host station to which said portable electronic entity is connected.

It finds one application in making a voice over IP (VoIP) call secure. The VoIP communication technique transmits voice messages over a communication network using the Internet Protocol (IP). In this transmission technique, voice is integrated into data transmitted over the network in packets.

Here the expression portable electronic entity refers to an electronic key or “dongle” that generally comprises an interface enabling it to be connected to a host station, which can be a workstation, a computer, a mobile telephone, a personal digital assistant, etc. The interface of the electronic key usually conforms to the USB (Universal Serial Bus) standard, which defines a universal serial bus system developed to provide simple and fast management of exchanges of data between a host station and a peripheral device, for example a portable electronic entity, a keyboard or other electronic device. The interface of the electronic key can equally conform to other standards such as the PCMCIA (Personal Computer Memory Card International Association) standard or the MMC (Multi Media Card) standard.

In the published patent application US 2004/0233901 A1, there has already been described an electronic key for setting up VoIP telecommunication by means of a USB interface connected to a personal computer. Here the USB electronic key comprises a data distribution circuit, a storage unit and a wireless radio-frequency audio module conforming to the WPAN (Wireless Personal Area Network) technology also known as Bluetooth. The wireless radio-frequency audio module of the USB electronic key enables a user equipped with a microphone and an earpiece that also conform to the wireless radio-frequency technology to exchange voice over short distances via a radio-frequency link.

After connection of the USB electronic key to the host computer and positive verification of an identifier associated with the USB electronic key, voice signals from the user are received by the radio-frequency module of the USB key and transmitted to the addressee via the Internet network.

This kind of USB electronic key therefore provides wireless voice over IP telephone communication with the aid of a USB electronic key equipped with a radio-frequency module conforming to the Bluetooth wireless technology.

Verification of the identifier with regard to the USB electronic key does not provide a totally satisfactory degree of security in that neither the host station nor the IP network between the host station and the communication server are in fact secure. As a result of this, a malicious person can obtain the identifier and/or the password associated with the USB key and use them fraudulently to set up a voice over IP call between the entity and the communication server.

The present invention solves this problem.

It aims in particular to make the voice over IP call set up in this way between the USB key and a server via the host station to which the USB is connected very secure.

It relates to a portable electronic entity comprising an interface to a host station and communication means adapted to set up a voice over IP call between said portable electronic entity connected in this way to the host station and a communication server connected to said host station via a communication network.

According to a general definition of the invention, the entity further comprises means for making the voice over IP call set up in this way between said portable electronic entity and the communication server secure in accordance with a chosen cryptographic mode.

Accordingly, the voice over IP communication session set up between the portable electronic entity and the communication server is made secure in accordance with a chosen cryptographic mode, which makes the communication session more secure than in the prior art cited above.

In one embodiment, the chosen cryptographic mode is an authentication protocol based on the response to a challenge generated by the communication server and comprising a sequence to be encrypted with a key and comparison of the encrypted sequence sent in this way.

The challenge/response protocol-based authentication protocol improves security in that the password is riot transmitted in clear over the wireless and/or IP networks.

The sequence to be encrypted is a pseudo-random number, for example.

In another embodiment, the chosen cryptographic mode is a protocol of mutual authentication between the communication server and the portable electronic entity, which provides a further degree of security in setting up the VoIP communication session between the portable electronic entity and the server.

In a preferred embodiment of the invention, the entity includes a mobile telephone network access identifier, the means for making the execution of the voice over IP application secure include a mobile telephone network access security key, and said means for making execution of the voice over IP application secure are adapted to make said voice over IP application between the entity 100 and a mobile telephone network secure with the aid of said mobile telephone network access identifier and said mobile telephone network access security key.

The interface between the portable electronic entity and the host station conforms to the USB standard. Alternatively, the interface of the portable electronic entity conforms to the PCMCIA standard or the MMC standard.

In practice the portable electronic entity further comprises a memory adapted to contain voice over IP application management software, processing means adapted to load and launch said management software coming from the memory in the host station after connection of the electronic entity to the host station, and execution means adapted to execute the communication application in accordance with said management software loaded and launched in this way.

The voice over IP application management software is preferably launched automatically after the connection of the portable electronic entity to the host station.

According to other features of the invention, combined where applicable:

the portable electronic entity further comprises means adapted to make at least in part the execution of the voice over IP application management software loaded and launched in the host station in this way secure in accordance with a chosen security mode, which provides a further degree of security when setting up the voice over IP call;

the means for making execution of the management software secure are of encryption/decryption type;

any modification made to the management software is made secure;

the management software comprises at least two parts: a main program executed by the host station and at least one auxiliary program stored and executed in said entity connected to said host station, the main program generating commands for execution of all or part of said auxiliary program;

the management software is divided into a plurality of sections each associated with an authentication code;

the authentication code is verified and in case of negative verification the operation of the management software is inhibited;

the means for making the management software secure are adapted to make said software secure with the aid of random elements belonging to the group formed by authentication codes and areas of division of said software, which provides a further degree of security;

the portable electronic entity further comprises an audio interface;

in case of negative verification with respect to the authentication code, the entity is adapted to inhibit the operation of the audio interface;

execution of the management software by the host station is accompanied by sending predetermined information to the entity in accordance with at least one sending condition and the means for making execution of the management software secure comprise verification means adapted to verify said sending condition;

the sending condition is related to the frequency of sending predetermined information and the entity further comprises measuring means adapted to measure said sending frequency;

the sending condition is linked to the size of the information and the entity further comprises measuring means adapted to measure said size of the information sent in this way.

The present invention also consists in a method of communication between a portable electronic entity comprising an interface to a host station and communication means adapted to execute an application for voice over IP type communication between said portable electronic entity connected in this way to the host station and a communication server connected to said host station via a communication network.

According to another aspect of the invention, the method further comprises a step of making execution of the application for voice over IP communication between said portable electronic entity and the communication server secure in accordance with a chosen cryptographic mode.

The present invention further consists in an information medium readable by a data processing system, where applicable removable, totally or partially, in particular CD-ROM or magnetic medium, such as a hard disk or a diskette, or transmissible medium, such as an electrical or optical signal, characterized in that it includes instructions of a computer program for executing the method referred to hereinabove if that program is loaded into and executed by a data processing system.

The present invention finally consists in a computer program stored on an information medium, said program including instructions for executing the method referred to hereinabove if that program is loaded into and executed by a data processing system.

Other features and advantages of the invention will become apparent in the light of the following detailed description and the drawings, in which:

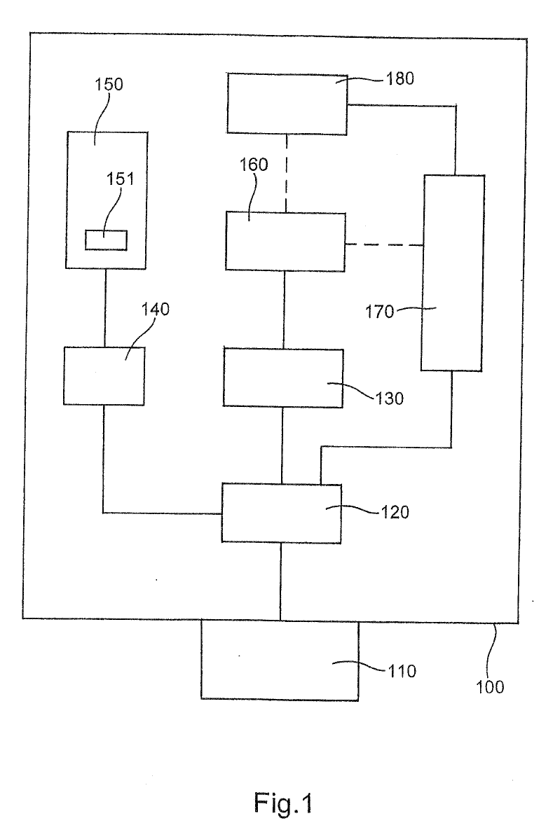

FIG. 1 represents diagrammatically the elements of a portable electronic entity according to the invention, and

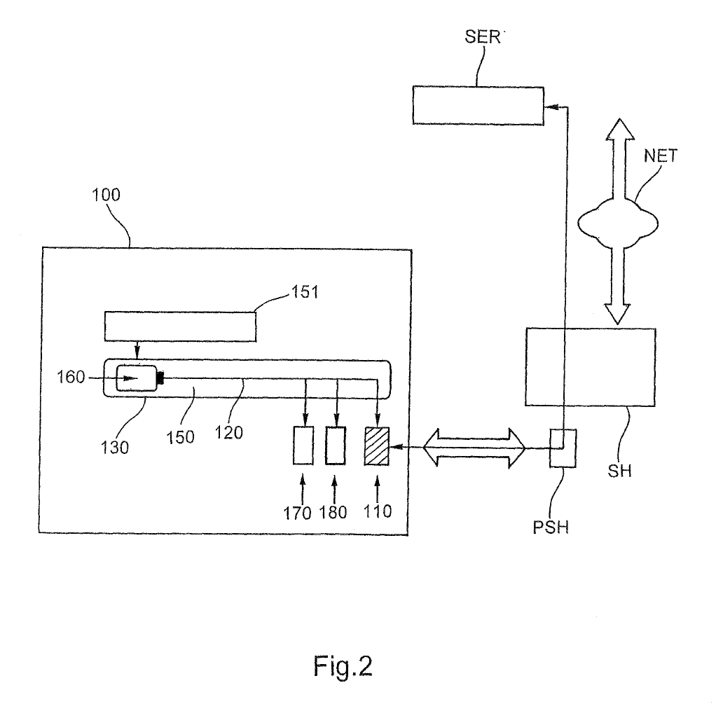

FIG. 2 represents diagrammatically the architecture of a platform using an entity from FIG. 1 to set up a voice over IP call with a server according to the invention.

Referring to FIG. 1, there are represented the constituent elements of a portable electronic entity 100 also known as a VoIP dangle or USB electronic key.

Referring to FIG. 2, the entity 100 comprises an interface 110 for connecting it to the port PSH of a host station SH.

The interface 110 and the port PSH are preferably ports conforming to the USB standard. Alternatively, the interfaces 110 and PSH are of PCMCIA or MMC type.

The host station SH is adapted to be connected to a communication server SER via a communication network NET such as the Internet network.

FIG. 1 is referred to again. The portable electronic entity 100 has a general shape comparable to that described in the application cited above (US 2004/0233901 A1). For example, the circuits that constitute it are typically mounted on a single printed circuit. Some or all functions can also be grouped together in a single integrated circuit. Other architecture variants will obviously be evident to the person skilled in the art.

A concentrator 120, also known as a hub, enables a number of peripherals conforming to the USB standard to be connected to the USB port 110 in a manner that is known in the art.

The entity 100 comprises a microchip card reader 130 conforming to the USB protocol. The microchip card reader 130 is advantageously a standard USB peripheral whose drivers are integrated into the operating system of the host station SH, which gives the advantage of avoiding preliminary installation of such drivers when using the USB key 100. For example, the microchip card reader comprises a CCID (Chip/smart Card Interface Device) USB type driver whose operation is described at http://www.microsoft.com/whdc/device/input/smartcard/USB CCID.mspx.

A microchip card 160 is housed in the microchip card reader 130. The microchip card 160 is an SIM (Subscriber Identity Module) for example. The reader 130 comprises a housing for receiving the module 160. A removable cover (not shown) enables insertion of the module 160 into the appropriate housing, for example.

As will emerge in more detail hereinafter, the subscriber identification module 160 includes security means adapted to make the voice over IP (VoIP) application between the communication server SER and the entity 100 via the host station SH secure in accordance with a chosen encryption mode.

Alternatively, the microchip card 160 is a secure microcontroller type circuit adapted to communicate in accordance with the ISO 7816 standard. This kind of secure controller is also capable of making the voice over IP (VoIP) application between the communication server SER and the entity 100 secure in accordance with a chosen cryptographic mode.

The entity 100 further comprises a memory 150. In practice, the memory 150 comprises at least one non-volatile portion. For example, the memory 150 is a 128 Mbyte Flash type memory.

The memory 150 is controlled by a controller 140.

In practice, the controller 140 is capable of emulating the operation of a CD ROM drive including autorun type software for managing the voice over IP application 151. In other words, the voice over IP application management software is executed automatically by the host station when the entity 100 is connected to said host station SH in accordance with the USB protocol.

Alternatively, the voice over IP application management software 151 is loaded into a non-volatile ROM area of the controller 140.

The entity further comprises an audio interface 180 and an audio processing module 170 for setting up the voice over IP (VoIP) call between the communication server SER and the user of the USB electronic key 100.

In practice, the audio processing module 170 receives from the server SER via the host station SH audio (voice) data intended for the audio interface 180. The audio processing module 170 also receives from the audio interface 180 audio data intended for the communication server SER.

The audio interface 180 comprises a microphone and a loudspeaker, for example. Alternatively, the audio interface 180 comprises a Bluetooth or similar type radio-frequency audio interface enabling remote exchange of voice with a radio-frequency earpiece worn by the user.

The audio processing module 170 comprises audio data processing means of digital/analog conversion, analog/digital conversion and amplification type. Such audio processing means are well known to the person skilled in the art.

This kind of audio processing module 170 can be located in a headset provided with a microphone and an earpiece if the audio interface 180 is of the short-range radio-frequency type.

The setting up of the voice over IP (VoIP) call with the aid of the entity 100 according to the invention is described next with reference to FIG. 2.

In a preferred embodiment, the server SER is connected to a mobile communication network, for example one conforming to the GSM (Global System for Mobile communications) standard. In this context, the connection with the mobile communication network is made secure in accordance with a chosen cryptographic mode.

For example, the chosen cryptographic mode is an authentication protocol based on the response to a challenge generated by the communication server SER and comprising a sequence to be encrypted with a key and comparison of the encrypted sequence sent in this way.

The authentication protocol based on the response to a challenge improves the security of the voice over IP call compared to the prior art cited above in wireless and/or IP networks.

The sequence to be encrypted is a pseudo-random number, for example.

This kind of authentication therefore verifies the rights of the portable electronic entity 100. If the authentication cryptographic process is successful, the voice over IP call is authorized.

In the context of mobile telephony, for example in the case of the GSM, the cryptographic process can use a function known as the A₃-A₈ function that enables the server SER of the operator concerned to authenticate the mobile electronic entity 100 that is seeking to be connected to it. This function is executed here by the SIM microchip card 160 placed in the entity 100 and on the basis of a mobile telephone network access identifier stored in the memory of the entity 100, preferably in the memory of the SIM microchip card 160, such as an IMSI (International Mobile Subscriber Identity) defined by the GSM standard, and on the basis of a key for making access to a mobile telephone network secure, also stored in the memory of the entity 100, preferably in the memory of the SIM microchip card 160. In addition to authentication of the user, the A₃-A₈ function generates a temporary key K_{c} for making the subsequent voice over IP call between the entity 100 and the server SER secure by encryption of a portion of the traffic. Thus the entity 100 includes means for making the voice over IP communication application between the entity 100 and a mobile telephone network secure.

According to another embodiment, the chosen cryptographic mode is a protocol for mutual authentication between the communication server SER and the portable electronic entity 100 for verifying their respective identities, which provides a further degree of security in setting up the VoIP communication session between the portable electronic entity and the server.

Alternatively, the communication channel between the entity 100 and the server SER is encrypted by means of a pair of asymmetrical keys. The entity 100 then comprises encryption/decryption means, which are of the crypto processor type, for example. A crypto processor of this kind can be accommodated in the audio module 170, for example, and controlled by the microchip card 160. In this context, after authentication of the server, the microchip card 160 can command the decryption, respectively the encryption on the fly of the data received by the server, respectively by the audio interface 180.

Security elements added to the voice over IP application management software are described next.

The VoIP application management software 151 is loaded automatically into the random access memory of the host station SH and executed by the host station on connection of the entity 100.

This automatic loading takes place when the port 110 of the entity 100 is engaged in the port PSH of the host station SH.

Alternatively, the user loads the software 151 onto the hard disk of the host station manually, for example using the graphical interface of the host station and the controller 140 for reading/writing the memory 150 of the entity 100. In this variant, the controller 140 does not need to emulate a CD ROM in accordance with the USB protocol.

The voice over IP application management software 151 can provide a number of functions.

For example, the software 151 manages the man-machine interface of the VoIP application. Thus the software 151 enables the user to enter the telephone number of the called person on the keypad and to display it on the screen.

The software 151 also manages the connection with the server SER and processes the audio signal transmitted by said server SER.

Execution of the software 151 is furthermore at least partially made secure in accordance with the invention.

First of all, loading and execution of the software 151 by the host station are preferably authorized following authentication of the bearer of the portable electronic entity 100.

For example, the authentication of the bearer of the entity 100 is of the password, identifier, PIN or key type.

For example, automatic launching of the software 151 can include a step requesting entry and verification of a PIN. This verification step is advantageously executed by the controller 140 or the microchip card 160.

Similarly, modification of the management software 151 can be made secure by a chosen cryptographic mode. For example, any modification is preceded by positive verification between the server SER and the entity 100 in accordance with the protocol for authentication of the bearer of the entity described hereinabove.

In another preferred embodiment of the invention, the management software 151 can comprise at least two parts: a main program executed by the host station SH and at least one auxiliary program stored in memory 150 and executed by the entity 100 when it is connected to said host station SH.

In this context, the main program generates commands for execution of all or part of said auxiliary program after positive verification in accordance with the protocol for authentication of the bearer of the entity described hereinabove.

According to a further embodiment, the management software 151 can include authentication sequences at given times during the execution of the voice over IP application.

Thus the software 151 can include instructions that consist in sending an authentication code coming from the host station SH addressed to the microchip card 160. If the authentication code received in this way does not correspond to the authentication code expected by the microchip card 160, the card 160 sends an instruction for inhibiting the operation of the audio processing module 170.

Alternatively, the inhibiting instruction can be sent to the audio interface 180 by the microchip card 160. To illustrate these inhibitions, there is represented in FIG. 1 a link in dashed line between the card 160 and the module 170 as well as between the card 160 and the audio interface 180.

The inhibiting instruction can also correspond to an item of data written specifically into non-volatile memory of the card 160, to prevent operation of the entity 100 in this way.

Making the software 151 secure can also include random elements to provide an additional degree of security.

Firstly, this random aspect can be applied if the management software 151 comprises authentication sequences consisting in sending authentication codes as described hereinabove. Thus these authentication codes can be random. Similarly, the time of sending these authentication codes can also be random, advantageously within a predetermined limited range.

Secondly, this random access can be applied if the software 151 is divided into two parts, a main part executed by the host station SH and an auxiliary part executed by the entity 100. For example, the division area or areas are then random. This random division can be effected on each loading of the software 151 into the host station SH, for example automatically following each connection of the key 100 to the host station SH.

For example, the software 151 could be predivided into a plurality of sections in a memory area of the memory 150 or in a ROM area of the controller 140. Each section is further associated with communication instructions enabling communication between the station SH and the entity 100. This association is operative, for example, in the case of division of the software 151 into a plurality of parts and/or when sending authentication codes as described hereinabove. Groups of contiguous sections are then selected randomly and, of the communication instructions associated with each section, only communication instructions separating two groups of sections selected in this way are executed. In practice, each section of the software can be a different size. Each section consists of codes written in machine language, assembler language, C, Java, etc.

To enhance protection further, the entity 100 can further include means for verification of a condition on the frequency of a certain type of data communicated to said entity 100 by the software 151 executed by the host station SH.

Thus the entity 100, and more particularly the microchip card 160, is capable of verifying the frequency with which authentication codes are received from the host station SH.

The frequency can be measured with respect to time. In this context, the entity 100 comprises a clock or any time measuring means. Alternatively, the frequency can be measured relative to another parameter such as the size or the number of bytes processed by the audio module 170.

The frequency condition is preferably associated with a threshold or a minimum frequency. Here the concept of frequency is to be understood in the broad sense. Indeed, a time delay can be started in the entity 100 on each code for authentication of the software 151 received from the station SH. At the end of the time delay, for example after one minute, if there has been no further authentication, an anomaly is detected leading for example to inhibition of the operation of the audio module 170 in response to a command coming from the microchip card 160.

Thanks to the invention, the bearer of the USB electronic key 100 can thus be connected to any host computer, without having to install voice over IP communication management software (controller or driver) or any audio equipment, and instantaneously set up a voice over IP application, without consideration as to the configuration of said host computer or to making their voice over IP communication session secure.

1. Portable electronic entity comprising an interface (110) to a host station (SH) and communication means adapted to execute an application for voice over IP type communication between said portable electronic entity (100) connected in this way to the host station (SH) and a communication server (SER) connected to said host station (SH) via a communication network (NET), characterized in that it further comprises means for making the voice over IP application secure adapted to make execution of the application for voice over IP communication between said portable electronic entity (100) and the communication server (SER) secure in accordance with a chosen cryptographic mode.

2. Entity according to claim 1, wherein the chosen cryptographic mode is an authentication protocol based on the response to a challenge generated by the communication server (SER) and comprising a sequence to be encrypted with a key and comparison of the encrypted sequence sent in this way.

3. Entity according to claim 2, wherein the sequence to be encrypted is a pseudo-random number.

4. Entity according to claim 1, wherein the chosen cryptographic mode is a protocol for mutual authentication of the communication server (SER) and the portable electronic entity (100).

5. Entity according to claim 1, wherein the cryptographic mode is of the asymmetrical key type and wherein said entity (100) comprises corresponding encryption/decryption means.

6. Entity according to claim 1, wherein the entity includes a mobile telephone network access identifier.

7. Entity according to claim 6, wherein the means for making execution of the voice over IP application secure include a key for making access to the mobile telephone network secure.

8. Entity according to claim 6, wherein the means for making execution of the voice over IP application secure are adapted to make said voice over IP application between the entity (100) and a mobile telephone network secure with the aid of said mobile telephone network access identifier and said key for making access to the mobile telephone network secure.

9. Entity according to claim 1, wherein the entity (100) comprises an interface (110) to the host station (SH) conforming to the USB standard.

10. Entity according to claim 1, wherein the entity (100) comprises an interface (110) to the host station (SH) conforming to the PCMCIA standard.

11. Entity according to claim 1, wherein the entity (100) comprises an interface (110) to the host station (SH) conforming to the MMC standard.

12. Entity according to claim 1, wherein said entity (100) further comprises a memory (150) adapted to contain voice over IP application management software (151), processing means adapted to load and launch said management software (151) coming from the memory (150) in the host station (SH) after connection of the electronic entity (100) to the host station (SH), and execution means adapted to execute the communication application in accordance with said management software (151) loaded and launched in this way.

13. Entity according to claim 12, wherein the voice over IP application management software (151) is launched automatically after connection of the portable electronic entity (100) to the host station (SH).

14. Entity according to claim 12 wherein the entity further comprises means adapted to make at least in part the execution of the voice over IP application management software (151) loaded and launched in the host station (SH) in this way secure in accordance with a chosen security mode.

15. Entity according to claim 14, wherein the means for making execution of the management software (151) secure are adapted to execute a protocol for authentication of the bearer of the entity (100) between said entity (100) and the host station (SH).

16. Entity according to claim 15, wherein the protocol for authentication of the bearer of the entity (100) is of the password, identifier or authentication code type.

17. Entity according to claim 14, wherein the means for making the software secure are further adapted to make any modification made to said management software (151) secure.

18. Entity according to claim 12, wherein the management software (151) comprises at least two parts: a main program executed by the host station (SH) and at least one auxiliary program stored and executed in said entity (100) connected to said host station (SH), the main program generating commands for execution of all or part of said auxiliary program.

19. Entity according to claim 18, wherein the auxiliary program is divided into a plurality of sections each associated with an authentication code.

20. Entity according to claim 19, wherein the authentication code is verified and in case of negative verification the operation of the management software (151) is inhibited.

21. Entity according to claim 12, wherein the means for making the management software (151) secure are adapted to make said software (151) secure with the aid of random elements belonging to the group formed by authentication codes and areas of division of said software (151).

22. Entity according to claim 20, wherein the portable electronic entity (100) further comprises an audio interface (180) and an audio processing module (170).

23. Entity according to claim 20, wherein, in case of negative verification with regard to the authentication code, the entity (100) is adapted to inhibit the operation of the audio interface (180) and/or the audio processing module (170).

24. Entity according to claim 14, wherein the execution of the management software (151) by the host station (SH) is accompanied by sending predetermined information to the entity (100) in accordance with at least one sending condition and wherein the means for making execution of the management software secure comprise verification means adapted to verify said sending condition.

25. Entity according to claim 24, wherein the sending condition is related to the frequency of sending predetermined information and wherein the entity further comprises measuring means adapted to measure said sending frequency.

26. Entity according to claim 24, wherein the sending condition is linked to the size of the information and wherein the entity (100) further comprises measuring means adapted to measure said size of the information sent in this way.

27. Method of communication between a portable electronic entity (100) comprising an interface (110) to a host station (SH) and communication means adapted to execute an application for voice over IP type communication between said portable electronic entity (100) connected in this way to the host station (SH) and a communication server (SER) connected to said host station (SH) via a communication network (NET), characterized in that it further comprises a step of making execution of the application for voice over IP communication between said portable electronic entity (100) and the communication server (SER) secure in accordance with a chosen cryptographic mode.

28. Method according to claim 27, wherein the chosen cryptographic mode is an authentication protocol based on the response to a challenge generated by the communication server (SER) and comprising a sequence to be encrypted with a key and comparison of the encrypted sequence sent in this way.

29. Method according to claim 28, wherein the sequence to be encrypted is a pseudo-random number.

30. Method according to claim 27, wherein the chosen cryptographic mode is a protocol for mutual authentication of the communication server (SER) and the portable electronic entity (100).

31. Method according to claim 27, wherein the cryptographic mode is of the asymmetrical key type and wherein said entity (100) comprises corresponding encryption/decryption means.

32. Method according to claim 27, wherein the entity (100) includes a mobile telephone network access identifier.

33. Method according to claim 32, wherein the means for making execution of the voice over IP application secure include a key for making access to the mobile telephone network secure.

34. Method according to claim 32, wherein the means for making execution of the voice over IP application secure are adapted to make said voice over IP application between the entity (100) and a mobile telephone network secure with the aid of said mobile telephone network access identifier and said key for making access to the mobile telephone network secure.

35. Method according to claim 27, characterized in that it further comprises the following steps:
providing a memory (150) adapted to contain voice over IP application management software (151),
loading and launching said management software (151) coming from the memory (150) in the host station (SH) after connection of the electronic entity (100) to the host station (SH), and
executing the voice over IP communication application in accordance with said management software loaded and launched in this way.

36. Method according to claim 35, wherein the voice over IP application management software (151) is launched automatically after the connection of the portable electronic entity (100) to the host station (SH).

37. Method according to claim 35, wherein the entity further comprises means adapted to make secure at least in part the execution of the voice over IP application management software (151) loaded and launched in the host station (SH) in this way in accordance with a chosen security mode.

38. Method according to claim 37, wherein making execution of the management software secure is a protocol for authentication of the bearer of the entity (100) and the host station (SH).

39. Method according to claim 38, wherein the protocol for authentication of the bearer of the entity (100) is of the password, identifier or authentication code type.

40. Method according to claim 37, wherein the means for making the software (151) secure are further adapted to make any modification made to said management software (151) secure.

41. Method according to claim 35, wherein the management software (151) comprises at least two parts: a main program executed by the host station (SH) and at least one auxiliary program stored and executed in said entity (100) connected to said host station (SH), the main program generating commands for execution of all or part of said auxiliary program.

42. Method according to claim 41, wherein the auxiliary program is divided into a plurality of sections each associated with an authentication code.

43. Method according to claim 42, wherein the authentication code is verified and in case of negative verification the operation of the management software (151) is inhibited.

44. Method according to claim 35, wherein the means for making the management software (151) secure are adapted to make said software (151) secure with the aid of random elements belonging to the group formed by authentication codes and areas of division of said software (151).

45. Method according to any claim 43, wherein the portable electronic entity (100) is provided with an audio interface (180) and an audio processing module (170).

46. Method according to claim 43, wherein, in case of negative verification with regard to the authentication code, the entity (100) is adapted to inhibit the operation of the audio interface (180) and/or the audio processing module (170).

47. Method according to claim 35, wherein the execution of the management software (151) by the host station (SH) is accompanied by sending predetermined information to the entity (100) in accordance with at least one sending condition and wherein the means for making the execution of the management software secure comprise verification means adapted to verify said sending condition.

48. Method according to claim 47, wherein the sending condition is related to the frequency of sending predetermined information and wherein the entity further comprises measuring means adapted to measure said sending frequency.

49. Method according to claim 47, wherein the sending condition is linked to the size of the information and wherein the entity (100) further comprises measuring means adapted to measure said size of the information sent in this way.

50. Information medium readable by a data processing system, where applicable removable, totally or partially, in particular CD-ROM or magnetic medium, such as a hard disk or a diskette, or transmissible medium, such as an electrical or optical signal, characterized in that it includes instructions of a computer program for executing a method according to claim 27 if that program is loaded into and executed by a data processing system.

51. Computer program stored on an information medium, said program including instructions for executing a method according to claim if that program is loaded into and executed by a data processing system.
